(19) United States
(12) Patent Application Publication
(10) Pub. No.: US 2012/0113153 A1
(43) Pub. Date: May 10, 2012

(54) METHODS OF ZERO-D DIMMING AND REDUCING PERCEIVED IMAGE CROSSTALK IN A MULTIVIEW DISPLAY

(75) Inventor: Glenn E. Casner, Woodbury, MN (US)

(73) Assignee: 3M Innovative Properties Company

(21) Appl. No.: 12/939,249

(22) Filed: Nov. 4, 2010

(51) Int. Cl. G09G 5/10

(52) U.S. Cl. 345/690

(57) ABSTRACT

Methods of implementing zero-D dimming and reducing perceived image crosstalk in a multiview display. One method includes providing an image stream to a display. The image stream includes a temporal sequence of images where at least a first image view and then a second image view are displayed on the display in a time sequential manner. Pixel luminance values are remapped for the first and second image views by applying a non-constant remapping function to original pixel luminance values of the first and second image views in order to generate new pixel luminance values. The temporal sequence of images are conditioned by generating new luminance values for the image pixels by applying a non-constant function to the original pixel luminance values and then modifying a color intensity of at least selected pixels along the horizontal dimension based on a non-constant crosstalk correction function for the horizontal dimension.

### BACKGROUND

A factor for multiview displays is image crosstalk or image ghosting, which occurs when one viewpoint receives a stimulus that was intended for another viewpoint. This produces a perceived or visible shadow or ghost on that image that reduces, or even inhibits, the viewer's display experience.

Two types of image crosstalk in a display include optical image crosstalk and timing image crosstalk. Timing image crosstalk refers to the timing of the light source and presentation of the image from on the display panel. Thus, if a first view image fails to erase before the illumination for the second image is provided to the display panel, then the first view image will be visible from the incorrect viewpoint, leading to timing image crosstalk. Optical image crosstalk refers to any non-ideal optical distribution of light from a first view spread, diffused or otherwise distributed into other views. For example, if the light intensity from a first view image is non-zero at the spatial or angular location of a second view image, then, as with timing image crosstalk, the first view image will be visible from an incorrect viewpoint, leading to optical image crosstalk.

Another factor for displays is power consumption, particularly for battery operated devices. Zero-D dimming has been developed to reduce power consumption while still having the display appear to have the same brightness. Typical zero-D backlight dimming transforms (remaps) or opens the pixels of a liquid crystal display such that a dimmed backlight plus transformed image results in a similar brightness perception compared to a 100 percentage on backlight and normal image. Pixel correction algorithms have been developed to implement zero-D dimming. These algorithms involve statistical analysis of pixel brightness and can be based on, for example, average frame luminance or luminance percentile statistics. The power savings capability with these algorithms has been experimentally demonstrated and can be as much as threefold while still maintaining reasonable display brightness perception. However, these algorithms have been developed for use with single view displays and their implementation with 3D or multiview displays often resulted in reduced or destroyed 3D perception.

### SUMMARY

A method of performing zero-D dimming and reducing perceived image crosstalk in a multiview display, consistent with the present invention, includes providing an image stream to a display, the image stream having a first image view and a second image view. Pixel luminance values are remapped for the first image view and the second image view by applying a non-constant remapping function to original pixel luminance values of the first image view and the second image view in order to generate new pixel luminance values. The first and second image views are also conditioned by modifying a color intensity of, at least selected, pixels along the horizontal dimension of the display based on a non-constant crosstalk correction function for the horizontal dimension.

### BRIEF DESCRIPTION OF THE DRAWINGS

The accompanying drawings are incorporated in and constitute a part of this specification and, together with the description, explain the advantages and principles of the invention. In the drawings,

FIG. 1 is a schematic side view of an illustrative display apparatus;

FIG. 2A and FIG. 2B are schematic side views of the illustrative display apparatus of FIG. 1 in operation;

FIG. 3 is a schematic side view of another illustrative display apparatus;

FIG. 4A and FIG. 4B are schematic side views of the illustrative display apparatus of FIG. 3 in operation;

FIG. 5 is a schematic front elevation view of an illustrative display;

FIG. 6 is an illustrative graph of percentage crosstalk along a horizontal pixel line in a first direction and a second direction;

FIG. 7 is a flow diagram of an illustrative method of reducing perceived image crosstalk in a multiview display;

FIG. 8 is a graph illustrating remapping image luminance values for zero-D dimming; and

FIG. 9 is a diagram of assessing perceived crosstalk reduction based upon user feedback.

### DETAILED DESCRIPTION

The term “autostereoscopic” refers to displaying three-dimensional images that can be viewed without the use of special headgear or glasses on the part of the user or viewer. These methods produce depth perception in the viewer even though the image is produced by a flat device. The term stereoscopic 3D incorporates the field of autostereoscopic devices but also includes the stereoscopic 3D display case in which special headgear, e.g. shutter glasses or polarized glasses, are need to see stereoscopic 3D from a flat display.

The term “disparity” refers to the difference in image location of a surface seen by the left and right eyes, resulting from the eyes' horizontal separation. Disparity is used to extract depth information from the two-dimensional retinal images in stereopsis. In this case disparity refers to the difference in left and right images based on the horizontal separation giving rise to 3D depth perception. In an alternative implementation, the correction algorithm might not take into consideration all disparity values but rather can only factor in those pixel differences that are noticeably different in terms of the human visual system sensitivity.

A liquid crystal display is a sample and hold display device such that the image at any particular point is stable until that point or pixel is updated at the next image refresh time, typically within 1/60 of a second or faster. In such a sample and hold system, displaying different images, specifically alternating left and right images for a 3D display, during sequential refresh periods of the display requires careful sequencing of the backlight light sources so that, for example, the left eye light source is not on during the display of data for the right eye and vice versa.

The present disclosure relates to methods of implementing zero-D dimming while also reducing perceived image crosstalk in a multiview display such as a 3D display. The zero-D dimming involves remapping pixel luminance values for the first image view and the second image view by applying a non-constant remapping function to original pixel luminance values of the first image view and the second image view in order to generate new pixel luminance values. The conditioning for perceived crosstalk reduction includes subtractive crosstalk reduction by altering or modifying pixel intensity of each image view so that the perceived image has a reduced amount of perceived image crosstalk thereby improving the viewing experience for an observer(s). In many embodiments, this conditioning is preformed by software that modifies color intensity of each image view frame of at least selected pixels of at least selected horizontal pixel lines by applying a known non-constant crosstalk function to the horizontal pixel lines. In many embodiments, this crosstalk function is determined empirically for the selected pixel lines and may be different along the pixel line for opposing directions of the pixel line. The modified images can be temporally displayed in sequence to reduce perceived image crosstalk. The disclosed method can be implemented to deal with non-uniform crosstalk, uniform crosstalk, or both. For example, the crosstalk correction algorithm could correct for crosstalk on a pixel by pixel basis using detailed information regarding what the amount of crosstalk is at any particular display location. While the present invention is not so limited, an appreciation of various aspects of the invention will be gained through a discussion of the examples provided below.

Methods for zero-D dimming in a 3D display and for perceived crosstalk reduction in a multiview display are described in, respectively, U.S. patent application Ser. No. 12/637,327, entitled “Zero-D Dimming for 3D Displays, and filed Dec. 14, 2009, and U.S. Patent Application Publication No. 2009/0167639, both of which are incorporated herein by reference as if fully set forth.

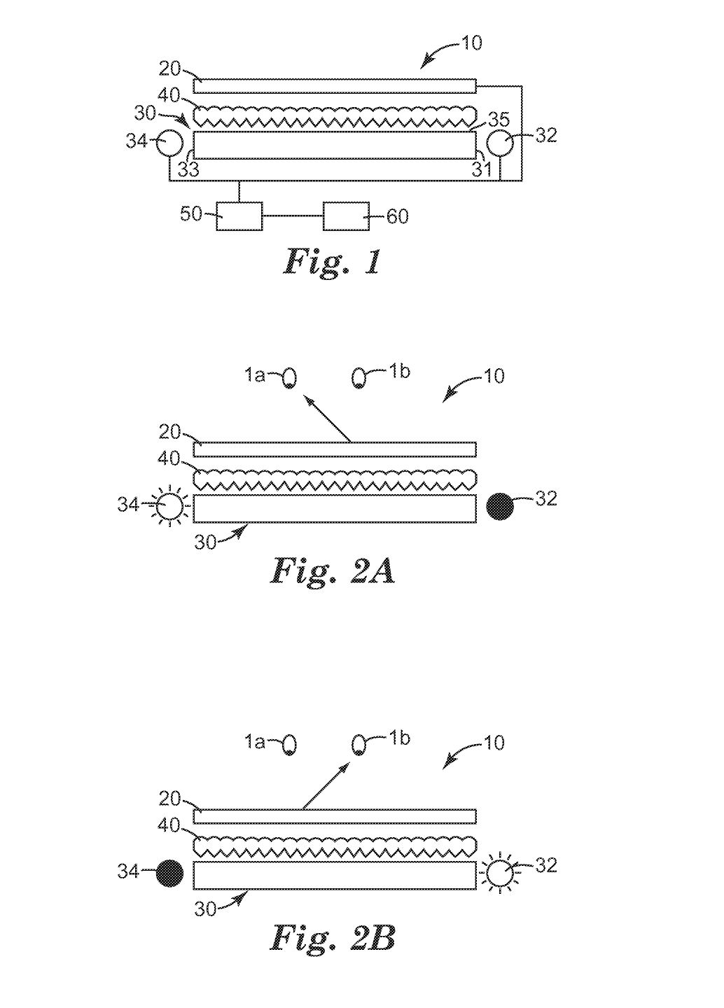

FIG. 1 is a schematic side view of an illustrative stereoscopic display apparatus 10. The display apparatus includes a liquid crystal display panel 20 having a frame response time of less than 10 milliseconds, or less than 5 milliseconds, or less than 3 milliseconds, and a backlight 30 positioned to provide light to the liquid crystal display panel 20. The backlight 30 includes a right eye image solid state light source 32 and a left eye image solid state light source 34 capable of being modulated between the right eye image solid state light source 32 and the left eye image solid state light source 34 at a rate of at least 90 Hertz. A double sided prism film 40 is disposed between the liquid crystal display panel 20 and the backlight 30.

The liquid crystal display panel 20 and backlight 30 can have any useful shape or configuration. In many embodiments, the liquid crystal display panel 20 and backlight 30 has a square or rectangular shape. However, in some embodiments, the liquid crystal display panel 20, backlight 30, or both has more than four sides or is a curved shape. While FIG. 1 is directed to any stereoscopic 3D backlight including those requiring shutter glasses or more than a single lightguide and associated liquid crystal display panel, the present disclosure is particularly useful for autostereoscopic displays. In other embodiments, the multiview display is OLED display, a plasma display, and the like.

A synchronization driving element 50 is electrically connected to the backlight 30 light sources 32, 34 and the liquid crystal display panel 20. The synchronization driving element 50 synchronizes activation and deactivation (modulation) of the right eye image solid state light source 32 and the left eye image solid state light source 34 as image frames are provided at a rate of 60 frames per second or greater to the liquid crystal display panel 20 to produce a flicker-free still image sequence, video stream or rendered computer graphics. An image (e.g., video or computer rendered graphics) source 60 is connected to the synchronization driving element 50 and provides the images frames (e.g., right eye images and left eye images) to the liquid crystal display panel 20.

The liquid crystal display panel 20 can be any transmissive liquid crystal display panel that has a frame response time of less than 10 milliseconds, or less than 5 milliseconds. Commercially available transmissive liquid crystal display panels having a frame response time of less than 10 milliseconds, or less than 5 milliseconds, or less than 3 milliseconds, are for example Toshiba Matsushita Display's (TMD) optically compensated bend (OCB) mode panel LTA090A220F (Toshiba Matsushita Display Technology Co., Ltd., Japan).

The backlight 30 can be any useful backlight that can be modulated between a right eye image solid state light source 32 and left eye image solid state light source 34 at a rate of at least 90 Hertz, or 100 Hertz, or 110 Hertz, or 120 Hertz, or greater than 120 Hertz. The illustrated backlight 30 includes a first light input surface 31 adjacent to the right eye image solid state light source 32 and an opposing second light input surface 33 adjacent to the left eye image solid state light source 34 and a light output surface 35. The solid state light sources can be any useful solid state light source that can be modulated at a rate of at least 90 Hertz. In many embodiments, the solid state light source is a plurality of light emitting diodes such as, for example, Nichia NSSW020B (Nichia Chemical Industries, Ltd., Japan). In other embodiments, the solid state light source is a plurality of laser diodes or organic light emitting diodes (OLEDs). The solid state light sources can emit any number of visible light wavelengths such as white, red, blue, or green. The backlight can be a single layer of optically clear material with light sources at both ends or two (or more) layers of optically clear material with a light source per layer which preferentially extract light in a desired direction for each layer.

The double sided prism film 40 can be any useful prism film having a lenticular structure on a first side and a prismatic structure on an opposing side. The double sided prism film 40 transmits light from the backlight to the liquid crystal display panel 20 at the proper angles such that a viewer perceives depth in the displayed image. Useful double sided prism films are described in United States Patent Applications Publication Nos. 2005/0052750 and 2005/0276071, which are incorporated herein by reference as if fully set forth. These double sided prism films have an open angle of about 60 degrees and provide image separation of approximately equal to the distance between a viewer's eyes, typically about six degrees.

The image source 60 can be any useful image source capable of providing images frames (e.g., first image view and left image views) such as, for example, a video source or a computer rendered graphic source. In many embodiments, the video source can provide image frames from 50 to 60 Hertz or greater. In many embodiments, the computer rendered graphic source can provide image frames from 100 to 120 Hertz or greater.

The computer rendered graphic source can provide gaming content, medical imaging content, computer aided design content, and the like. The computer rendered graphic source can include a graphics processing unit such as, for example, an Nvidia FX5200 graphics card, a Nvidia GeForce 9750 GTX graphics card or, for mobile solutions such as laptop computers, an Nvidia GeForce GO 7900 GS graphics card. The computer rendered graphic source can also incorporate appropriate stereo driver software such as, for example, OpenGL, DirectX, or Nvidia proprietary 3D stereo drivers.

The video source can provide video content. The video source can include a graphics processing unit such as, for example, an Nvidia Quadro FX1400 graphics card. The video source can also incorporate appropriate stereo driver software such as, for example, OpenGL, DirectX, or Nvidia proprietary 3D stereo drivers.

The synchronization driving element 50 can include any useful driving element providing synchronizing activation and deactivation (modulation) of the right eye image solid state light source 32 and the left eye image solid state light source 34 with image frames provided at a rate of 90 frames per second or greater to the liquid crystal display panel 20 to produce a flicker-free video or rendered computer graphics. The synchronization driving element 50 can include a video interface such as, for example, a Westar VP-7 video adaptor (Westar Display Technologies, Inc., St. Charles, Mo.) coupled to custom solid state light source drive electronics.

FIG. 2A and FIG. 2B are schematic side views of an illustrative stereoscopic display apparatus 10 in operation. In FIG. 2A the left eye image solid state light source 34 is illuminated and the right eye image solid state light source 32 is not illuminated. In this state, the light emitted from the left eye image solid state light source 34 transmits through the backlight 30, through the double sided prism sheet 40, and liquid crystal panel 20 providing a first image view (left eye image) directed toward the left eye 1a of an viewer or observer.

In FIG. 2B the right eye image solid state light source 32 is illuminated and the left eye image solid state light source 34 is not illuminated. In this state, the light emitted from the right eye solid state light source 32 transmits through the backlight 30, through the double sided prism sheet 40, and liquid crystal panel 20 providing a second image view (right eye image) directed toward the right eye 1b of an viewer or observer.

Providing at least 45 left eye images and at least 45 right eye images (alternating between right eye and left eye images and the images are possibly a repeat of the previous image pair) to a viewer per second provides a flicker-free 3D image to the viewer. Accordingly, displaying different right and left viewpoint image pairs from computer rendered images or images acquired from still image cameras or video image cameras, when displayed in synchronization with the switching of the light sources 32 and 34, enables the viewer to visually fuse the two different images, creating the perception of depth from the flat panel display. A limitation of this visually flicker-free operation is that, as discussed above, the backlight should not be on until the new image that is being displayed on the liquid crystal display panel has stabilized, otherwise crosstalk and a poor stereoscopic image will be perceived.

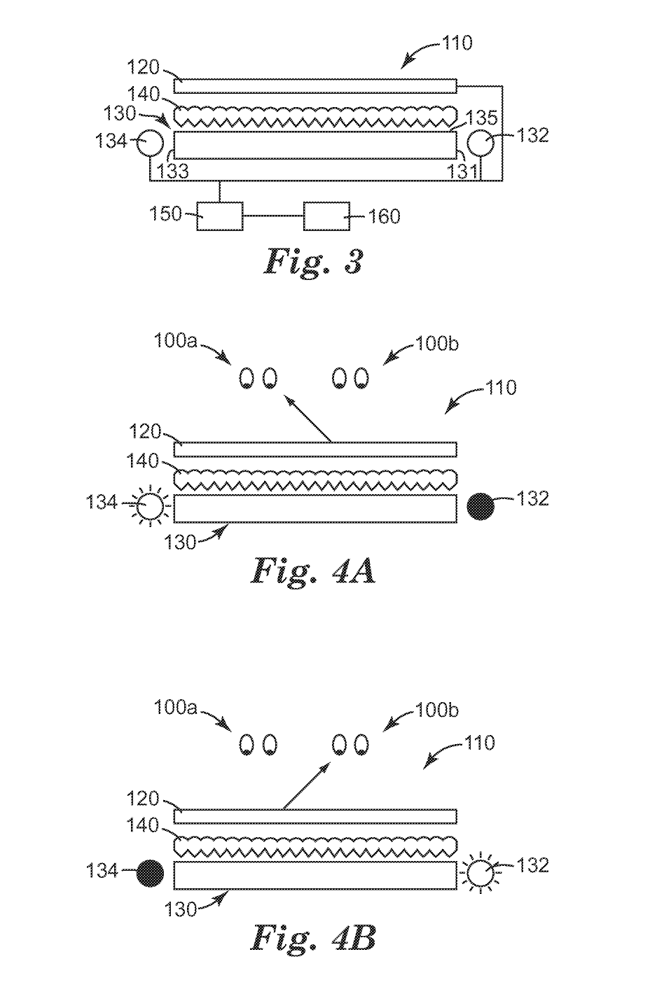

FIG. 3 is a schematic side view of an illustrative dual view 2D display apparatus 110. The display apparatus includes a liquid crystal display panel 120, as described above, and a backlight 130 positioned to provide light to the liquid crystal display panel 120, as described above. The backlight 130 includes a right view image solid state light source 132 and a left view image solid state light source 134 capable of being modulated between the right view image solid state light source 132 and the left view image solid state light source 134 at a rate of at least 90 Hertz, as described above. A double sided prism film 140 is disposed between the liquid crystal display panel 120 and the backlight 130.

A synchronization driving element 150 is electrically connected to the backlight 130 light sources 132, 134 and the liquid crystal display panel 120. The synchronization driving element 150 synchronizes activation and deactivation (modulation) of the right view image solid state light source 132 and the left view image solid state light source 134, as described above. An image (e.g., video or computer rendered graphics) source 160 is connected to the synchronization driving element 150 and provides the images frames (e.g., right view images and left view images) to the liquid crystal display panel 120, as described above.

The backlight 130 can be any useful backlight, as described above. The illustrated backlight 130 includes a first light input surface 131 adjacent to the right view image solid state light source 132 and an opposing second light input surface 133 adjacent to the left view image solid state light source 134 and a light output surface 135. The solid state light sources can be any useful solid state light source, as described above.

The double sided prism film 140 can be any useful prism film having a lenticular structure on a first side and a prismatic structure on an opposing side, as described above. The double sided prism film 140 transmits light from the backlight to the liquid crystal display panel 120 at the proper angles such that each viewer perceives the proper displayed image. Useful double sided prism films are described in United States Patent Applications Publication Nos. 2005/0052750 and 2005/0276071, which are incorporated herein by reference as if fully set forth. While this reference describes a double sided prism films useful for a 3D image, the prism open angles and pitch can be modified to separate the output viewing angle of each image view so as to separate the two image views for viewing by two viewers. For example, the prism open angle can be in a range from 70 to 89 degrees and the prism pitch can be in a range from 1 to 50 micrometers to form the proper output viewing angle of each image view for a 2D dual view display. In other embodiments, the double sided prism film is not needed for a 2D multiview display, as described below.

The image source 160 can be any useful image source capable of providing images frames (e.g., first image view and left image views) such as, for example, a video source or a computer rendered graphic source, as described above. The synchronization driving element 150 can include any useful driving element providing synchronizing activation and deactivation (modulation) of the right view image solid state light source 132 and the left view image solid state light source 134 with image frames provided at a rate of 90 frames per second or greater to the liquid crystal display panel 120 to produce a flicker-free video or rendered computer graphics, as described above.

FIG. 4A and FIG. 4B are schematic side views of the illustrative dual view display apparatus 110 in operation. In FIG. 4A the left view image solid state light source 134 is illuminated and the right view image solid state light source 132 is not illuminated. In this state, the light emitted from the left view image solid state light source 134 transmits through the backlight 130, through the double sided prism sheet 140, and liquid crystal panel 120 providing a first image view (left view image) directed toward the left viewer 100a or observer 100a.

In FIG. 4B the right view image solid state light source 132 is illuminated and the left view image solid state light source 134 is not illuminated. In this state, the light emitted from the right view solid state light source 132 transmits through the backlight 130, through the double sided prism sheet 140, and liquid crystal panel 120 providing a second image view (right view image) directed toward the right viewer 100b or observer 100b.

The methods to implement zero-D dimming and reduce perceived image crosstalk described herein can also be applied to displays that display three or more distinct image views. Illustrative examples of multiview 2D/3D displays are described in, for example, IJzerman et al., “Design of 2D/3D Switchable Displays”, SID 2005 DIGEST, pg. 98-101: and Kim et al., “A 2.4 inch 4-view 3D Display”, IDW 2007, pg. 2263-2266, which are incorporated herein by reference as if fully set forth. Some of these displays provide multiview images to the display simultaneously. In addition to 3D displays, the methods can also be used in other types of multiview displays using two image views, such as the multiview display described in U.S. Patent Application Publication No. 2009/0167639, which is incorporated herein by reference as if fully set forth.

This disclosure describes conditioning the image views to both implement zero-D dimming and reduce perceived image crosstalk in a multiview display. The zero-D dimming involves remapping pixel luminance values for the first image view and the second image view by applying a non-constant remapping function to original pixel luminance values of the first image view and the second image view in order to generate new pixel luminance values. The conditioning for perceived crosstalk reduction includes subtractive crosstalk reduction by altering or modifying pixel intensity of each image view, meaning one or more of the image views, so that the perceived image has a reduced amount of perceived image crosstalk thereby improving the viewing experience for an observer(s). The general idea is to subtract an amount of intensity from at least selected or each pixel in the displayed image to compensate for the perceived image leakage of intensity from the prior or subsequent image frame. In some embodiments, the image color intensity scale is re-scaled so that the displayed pixel has an initial intensity so as to allow one to modify the initial intensity the required amount. The method can be accomplished via software solution and implemented in real time, as described below.

These methods includes providing an image stream to a display and conditioning the image stream pixel color intensity to reduce perceived image crosstalk in the multiview display. The image stream includes a temporal sequence of images where at least a first image view and then a second image view is displayed on the display in a time sequential manner, or in a simultaneously manner. Crosstalk is determined and corrected as a function (non-constant) of the display width or along a horizontal dimension of the display.

A method of non-uniform crosstalk reduction as a function of screen height for stereoscopic CRT displays that suffer from phosphor after-glow is described in a journal article to Smit et al., “Non-Uniform Crosstalk Reduction for Dynamic Scenes,” IEEE Virtual Reality Conference 2007 Mar. 10-14, pages 139-146, which is incorporated herein by reference as if fully set forth.

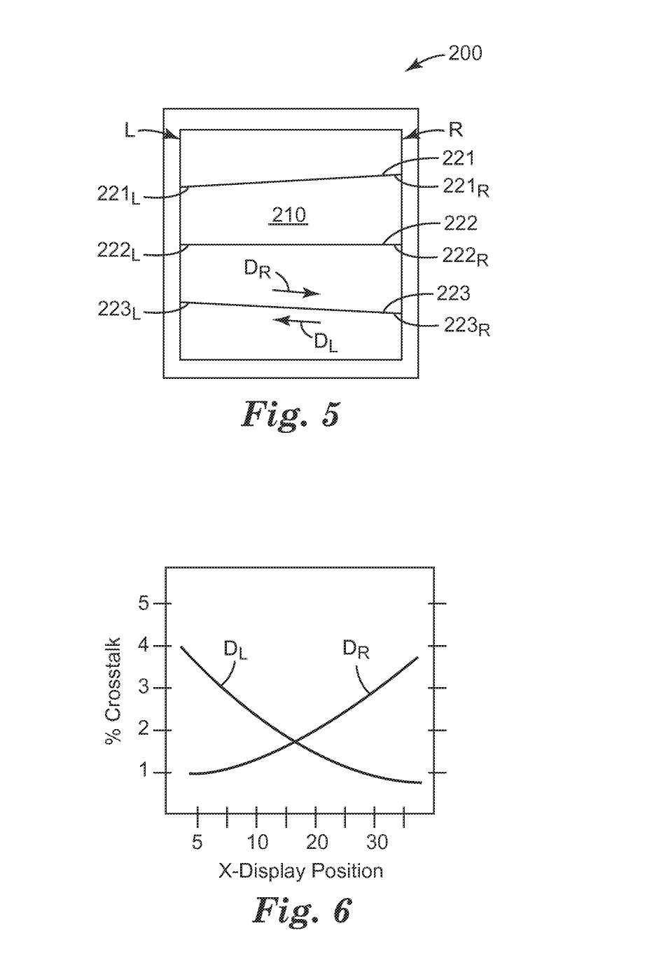

Referring to FIG. 5, the display 200 includes a horizontal dimension 221, 222, 223 (across a width of display) that extend from a first side R of the display to an opposing second side L of the display. The horizontal dimension 221, 222, 223 has a first end 221_{R}, 222_{R}, 223_{R} and an opposing second end 221_{L}, 222_{L}, 223_{L}, defining a length therebetween. The horizontal dimension 221, 222, 223 is formed by a plurality of points, pixels, or areas on the display that extend horizontally across the width of the display from the first end to the second end, or vice versa. The horizontal dimension can extend straight 222 across the display or in a diagonal 221, 223 across the display.

The images or temporal sequence of images are conditioned or modified before being displayed on the display to reduce perceived displayed image crosstalk between the, at least, first image view and the second image view. The conditioning includes modifying a color intensity of, at least selected, pixels along, the horizontal dimension based on a non-constant crosstalk correction function for the horizontal dimension.

FIG. 6 is an illustrative graph of percentage crosstalk along a horizontal dimension in a first direction D_{L} and a second direction D_{R}. In many embodiments, the percentage crosstalk is a non-constant function across the horizontal direction D_{R} or D_{L} or length of the horizontal dimension. In many embodiments, the percentage crosstalk is a non-linear function across the horizontal direction D_{R} or D_{L} or length of the horizontal dimension. In some embodiments, the percentage crosstalk is a linear function across the horizontal direction D_{R} or D_{L} or length of the horizontal dimension. In many embodiments, the percentage crosstalk is a different function along the horizontal dimension in a first direction D_{L} than the percentage cross talk function in the second direction D_{R} along the horizontal dimension. In addition the horizontal dimension can have a distinct percentage crosstalk along the horizontal dimension in a first direction D_{L} and a second direction D_{R}.

In many embodiments, these percentage crosstalk values across the horizontal dimension are empirically determined for a specific display and then a curve-fit analysis provides the function or equation (as a function of width or length) useful for the method described herein.

In some embodiments, color intensity of each color is resealed so that the modified color intensity of each color is within the color intensity range for that color. The color intensity range can be any useful range such as, for example, 0 to 63 (6 bit), or 0 to 255 (8 bit), 0 to 1023 (10 bit), or 12 bit, or 14 bit, or 16 bit. Thus for example, an 8-bit color intensity could be resealed to 20 to 255 if the desired pixel color intensity is 10 and modified pixel color intensity is set to 0.

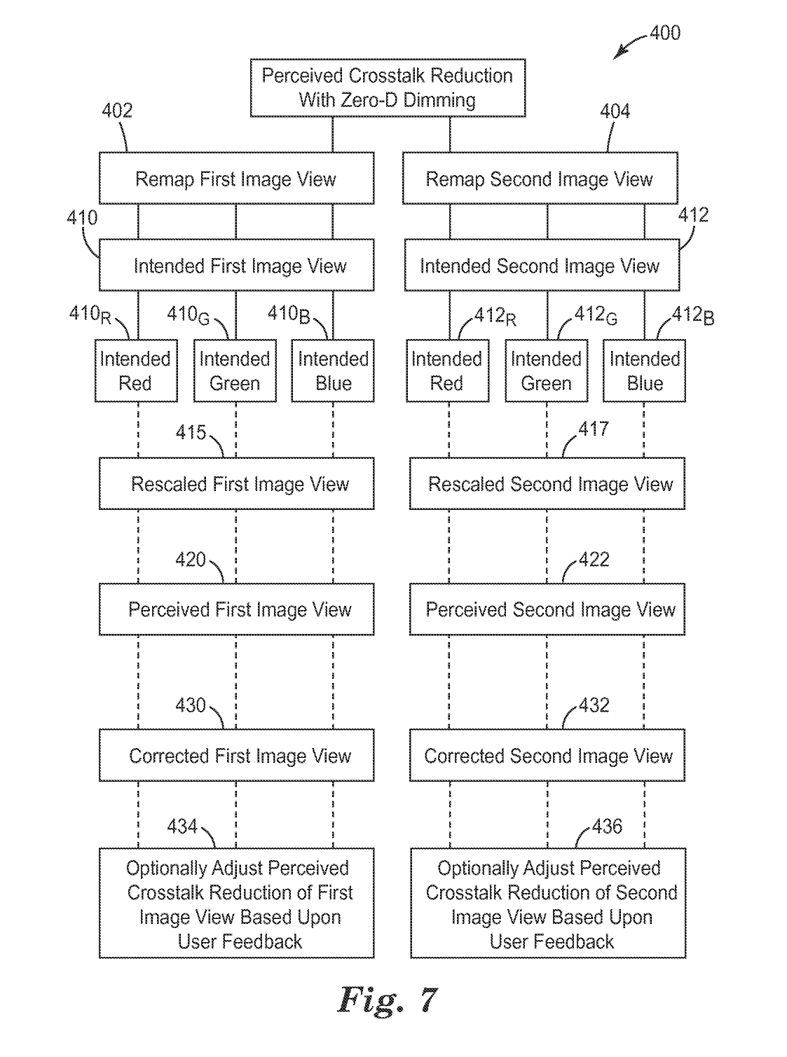

FIG. 7 is a flow diagram 400 of an illustrative method of implementing zero-D dimming and reducing perceived image crosstalk in a multiview display. This method artificially creates some additional room at the ends of the pixel value spectrum in zero-D dimming to allow more room to perform perceived crosstalk reduction following zero-D dimming. The method uses a remapping system for the zero-D dimming that remaps the original pixel values to a sub-range of the original 0 to 255 range (e.g., 15 to 245). Such a remapping ensures that there is always some room for perceive crosstalk reduction compensation at the two pixel extremes. Other sub-ranges can be used for the zero-D dimming.

Method 400 first remaps the first image view at block 402 and remaps the second image view at block 404 to implement zero-D dimming. The advantage of this zero-D dimming is backlight power savings, an important benefit in portable battery operated displays. Zero-D dimming for 3D or multiview displays provides zero-D dimming using right and left image data. The zero-Dimming remapping is implemented using this right and left image data in such a way as to maintain much of the original disparity information.

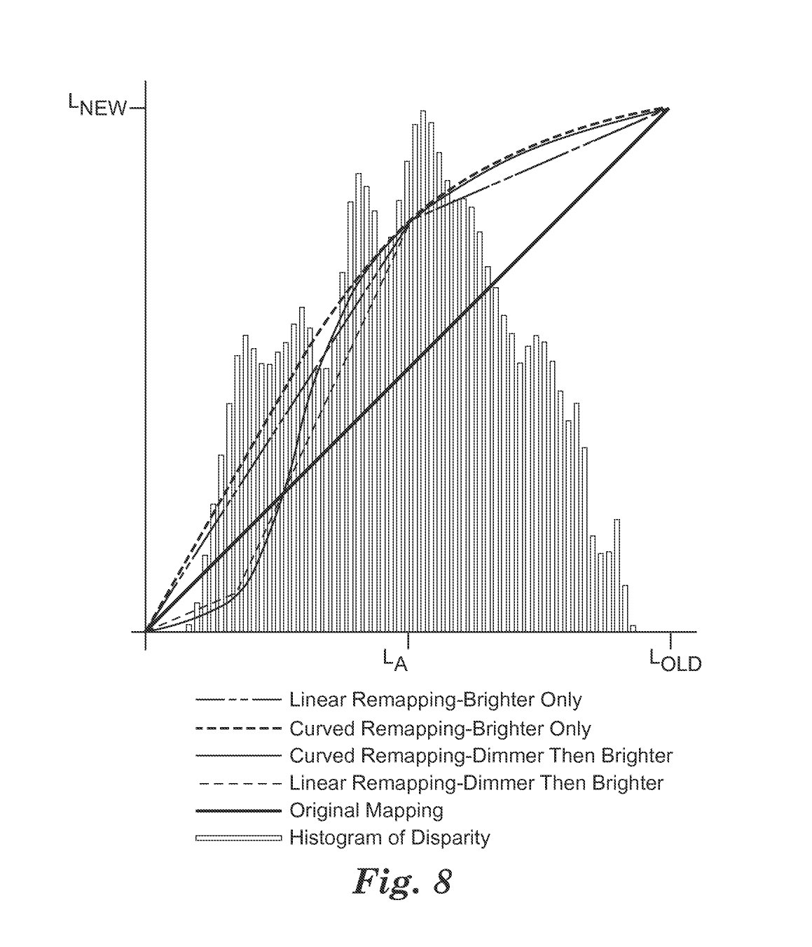

FIG. 8 illustrates possible remapping schedules for zero-D backlight dimming in order to transform (remap) or open the pixels, although other remapping schedules are possible. The luminance values for the pixels are remapped from the original luminance values L_{OLD} to new luminance values L_{NEW}. The value L_{A} represents the average luminance values of the pixels. As shown in FIG. 8, with no remapping the new pixel luminance values equal the original luminance values (L_{NEW}=L_{OLD}). The remapping involves applying a non-constant remapping function to the values of L_{OLD} in order to generate the values for L_{NEW}. As illustrating in FIG. 8, the non-constant function for the remapping can include a linear remapping for brighter only L_{NEW} values based upon the L_{OLD} values, a curved remapping for brighter only L_{NEW} values, a curved remapping for dimmer then brighter L_{NEW} values, and a linear remapping for dimmer then brighter L_{NEW} values. Other remapping schemes may be possible.

Pixel remapping can be implemented in software via a look-up table or an equation. For example, a linear remapping, dimmer then brighter such as shown in FIG. 8, can be implemented via the following equations. For pixel values from zero to the lower threshold (X_{L} (e.g., 5 percentage Disparity Threshold)) remapping could=X_{OLD} (or the original pixel value)*R_{D} (or the Remapping Factor Dimmer (e.g., 0.75). For pixel values from X_{L} to upper threshold (X_{U} (e.g., 85 percentage Disparity Threshold) remapping could={[((X_{U}*R_{B} (or Remapping Factor Brighter (e.g., 1.25)))−(X_{L}*R_{D})]*(X_{OLD}−X_{L})}+(X_{L}*R_{D}). For pixel values from X_{U} to 255 remapping could={[(255−(X_{U}*R_{B})]*(X_{OLD}−X_{U})}+(X_{U}*R_{B}).

The next step in method 400 is to identify the intended images at block 410 for the first image view and at block 412 for the second image view. In this example, a color intensity value for red 410_{R}, 412_{R}, green 410_{G}, 412_{G}, and blue 410_{B}, 412_{B} is determined for each intended image view.

Then the intended image views 410 and 412 color intensity values for red 410_{R}, 412_{R}, green 410_{G}, 412_{G}, and blue 410_{B}, 412_{B} are each independently rescaled at block 415, and block 417, so that the corrected images at block 430 and block 432 maintain the original color intensity scale (e.g., 0 to 255 for an 8-bit scale). This rescaling makes perceived crosstalk reduction possible for all pixel values; without rescaling perceived crosstalk reduction may not be possible for some pixel values. Rescaling is optional and need not be used for perceived crosstalk reduction in some embodiments. One possible implementation for rescaling includes:

correction_factor=((255−((255*(1−maximum_crosstalk_percentage))+(crosstalk_percentage*0)))); and (1)

Rescaler=1−(2*maximum_crosstalk_percentage in the display). (2)

This implementation is assuming the maximum rescaling is necessary. That is, the implementation is assuming that for at least one pixel location there is the condition where one of the intended images value is 255 and the corresponding pixel value in a second intended is 0. Thus, this implementation can be characterized with the following equations, where A=First Image View Color Intensity; B=Second Image View Color Intensity:

Rescaled_{—}A_Red=intended_{—}A_Red*Rescaler+correction factor

Rescaled_{—}B_Red=intended_{—}B_Red*Rescaler+correction factor

Rescaled_{—}A_Green=intended_{—}A_Green*Rescaler+correction factor

Rescaled_{—}B_Green=intended_{—}B_Green*Rescaler+correction factor

Rescaled_{—}A_Blue=intended_{—}A_Blue*Rescaler+correction factor

Rescaled_{—}B_Blue=intended_{—}B_Blue*Rescaler+correction factor

The perceived image, block 420, 422 is a combination of one minus the crosstalk percentage of the resealed image view plus crosstalk percentage of the unintended resealed image view, for each color intensity value. For example, if the intended resealed pixel value is 10 and the amount of crosstalk at that particular display position is 10 percent, and the unintended resealed image pixel value is 100, then the predicted perceived pixel value would be 19.

Thus, the corrected image, block 430, 432 equals the resealed intended image plus the difference between the resealed intended image and the predicted perceived image. For example, if at a given pixel in the intended resealed image should be 10 and the pixel is predicted perceived is 19 due to X amount of crosstalk from the unintended image, then the pixel in the corrected image would be l.

Thus, one possible implementation of this method includes: for i=l:Image_height;

and for j=Image-width; and k and l are functions (equations) characterizing the display in terms of crosstalk horizontally across the display in a first direction (k) and in a second opposing direction (l) for a given pixel line of the display.

k=((0.0000012712*(j)²)−(0.0001655478*(j))+(0.1049456489))

l=((0.0000012712*(j)²)−(0.0011565091*(j))+(0.3625955732))

Perceived_{—}A_Red(i,j)=((l−k)*Rescaled_{—}A_Red(0+k*Rescaled_{—}B_Red(i,j)

Corrected_{—}A_Red(i,j)=Rescaled_{—}A_Red(0+(Rescaled_{—}A_Red(i,j)−Perceived_{—}A_Red(i,j)))

Method 400 can optionally include adjusting the perceived crosstalk reduction of the first image view based upon user feedback at block 434 and adjusting the perceived crosstalk reduction of the second image view based upon user feedback at block 436. Due to differences in user behavior (e.g., viewing distance and eye separation) the crosstalk for user X for a given display at a given time may not be the same as for user Y for the same display at the same time, therefore allowing a particular user to calibrate his or her own display can be optimal.

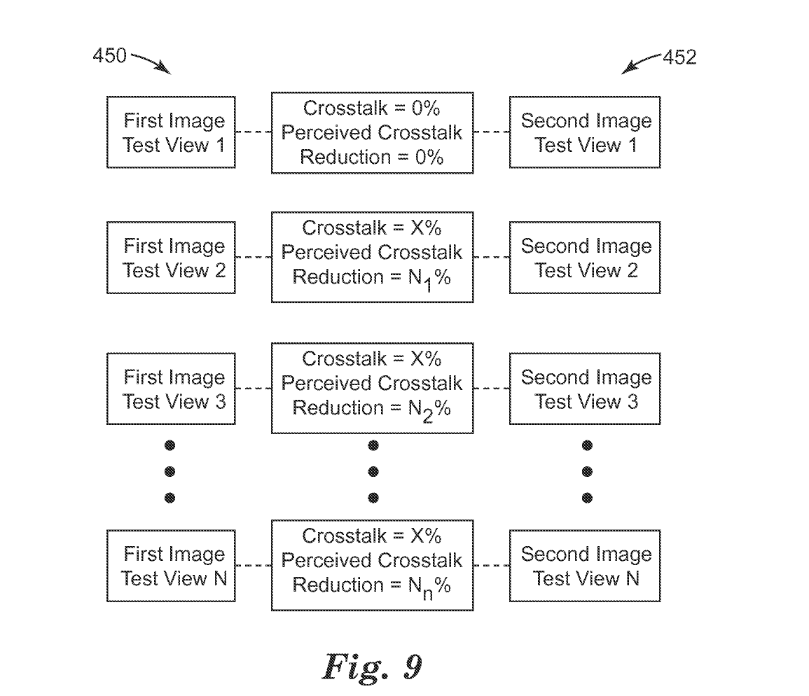

FIG. 9 is a diagram of assessing perceived crosstalk reduction based upon user feedback. A series of first image test views 450 and a series of second image test views 452 are presented to a user on a display device such as display apparatus 10. The test images could be generated in such a way as to be easily identified as X view (e.g., Image A—left eye view image), and could be generated in such a way as to allow for quantification of crosstalk level. The base image, first and second test view images 1, are typically shown to the user with zero actual crosstalk and zero perceived crosstalk reduction. The remaining test view images are typically shown with the same or a constant amount of crosstalk (X %) and increasing amounts of perceived crosstalk reduction from N₁% to N. %. For example, the first and second test view images can be shown with 15% crosstalk and perceived crosstalk reduction increasing in increments of 2.5% from N₁=0% to Nₙ=20%.

Crosstalk quantification could be accomplished by objective visual assessment (computerized or human) or subjectively. An example of an objective assessment can involve using a photometer to determine the optimal amount of perceived crosstalk reduction correction at various points along the display. An example of a subjective assessment can involve use a calibration program appearing on the display, such as in a pop up window, that allows the user to identify which amount of perceived crosstalk reduction compensation is optimal at a given point on the display for a particular view. Such an assessment could be done at one or more locations on the display. Once the viewer has indicated how much compensation is ideal, this information could be used to characterize crosstalk across the display, and this information would then be used for the purposes of perceived crosstalk reduction correction.

Human visual crosstalk assessment could include test images, as illustrated in FIG. 9, generated in such a way as to maximize an individual's sensitivity to crosstalk. For example, the test images could be constructed so as to be comprised of multiple bars that would enable multiple simultaneous comparisons of different grayscale or color scale values. In addition such test images could be constructed based on knowledge of human just noticeable differences, such that the ability of an individual to visual discriminate between two bars is informative about the amount of visual crosstalk.

Such a crosstalk assessment tool could be utilized as a method of first determining optimal viewpoint location in terms of minimizing crosstalk, second informing the user if he or she is optimally located in terms of minimizing crosstalk (e.g., in terms of distance from the display or in terms of “sweet spot” centering). Also, feedback can be displayed to the user giving position alteration suggestions (e.g., if your left eye perception resembles that of Image C then move to the left direction until image looks like Image A), or using user location information to alter display setup. For example, based on feedback provided by the user, one could determine approximate user location relative to the display and such knowledge may be used to alter display setup to increase viewing experience.

The adjustment based upon user feedback at blocks 434 and 436 can be performed with both the zero-D dimming and perceived crosstalk reduction described above, with just the perceived crosstalk reduction, or alone without either the zero-D dimming or crosstalk reduction.

Method 400 can be performed on a frame by frame basis for the image data or views. The term “frame” means a full frame of right and left image data for a particular display or any partial frame of the data on the display. Method 400 can alternatively be implemented on a line by line basis for the image data. For example, some displays, particularly hand held displays, may have a line buffer but not a frame buffer, in which case the method can be executed line by line.

Table 1 provides sample code to implement an algorithm to both perform zero-D dimming and perceived crosstalk reduction in a multiview display. This sample code can be implemented electronically in the synchronizing driving element 50, for example. The sample code can also be implemented in a computer program product containing instructions in a computer-readable media, such as an electronic computer memory or other electronic storage device, for use in controlling the operation of a processor.

TABLE 1
Sample Code for Zero-D Dimming with
Perceived Crosstalk Reduction (PCR)

% ----------------------------- Clear All -----------------------------
close all; clear all; clc;
% ----------------------------- Load Originals -------------------------
Loriginal = imread(‘Original_Image_L.bmp’);
Roriginal = imread(‘Original_Image_R.bmp’);
% ----------------------- Determine Image Size ------------------------
Image_Size = size(Loriginal);
Image_Height = Image_Size(1,1);
Image_Width = Image_Size(1,2);
% ------------------- Generate Single Layer Triplet -------------------
L1 = zeros(Image_Height, (Image_Width*3));
R1 = zeros(Image_Height, (Image_Width*3));
L1(1:Image_Height,1:Image_Width) = Loriginal(:,:,1);
L1(1:Image_Height,(Image_Width+1):(Image_Width*2)) =
Loriginal(:,:,2);
L1(1:Image_Height,(Image_Width*2+1):(Image_Width*3)) =
Loriginal(:,:,3);
R1(1:Image_Height,1:Image_Width) = Roriginal(:,:,1);
R1(1:Image_Height,(Image_Width+1):(Image_Width*2)) =
Roriginal(:,:,2);
R1(1:Image_Height,(Image_Width*2+1):(Image_Width*3)) =
Roriginal(:,:,3);
% ----------- Determine Average Luminance of 8 Bit Original -----------
averagelum_L1 = median(median(L1));
averagelum_R1 = median(median(R1));
if averagelum_L1 >= averagelum_R1;

averagelum = averagelum_L1;

else

averagelum = averagelum_R1;

end
% ------------------- Characterizing the Disparity --------------------
VectorOriginal=sort(L1(:));
cutoff_value = VectorOriginal(round(0.85*size(VectorOriginal,1)));
%0.85 is the 85% cutoff. The Upper Threshold.
L2 = zeros(Image_Height, (Image_Width*3));
R2 = zeros(Image_Height, (Image_Width*3));
Remapping_schedule = load(‘remapping_lookup_table.txt’);
%If remapping schedule is via a look-up table.
for Hh = 1:Image_Height;

for Ww = 1:(Image_Width*3);

for pixelvalues = 255:−1:0;

if L1(Hh,Ww) == pixelvalues;

row_lookup = (((255-pixelvalues))+1);
L2(Hh,Ww) = Remapping_schedule(row_lookup,9);

end

end

end

end
for Hh = 1:Image_Height;

for Ww = 1:(Image_Width*3);

for pixelvalues = 255:−1:0;

if R1(Hh,Ww) == pixelvalues;

row_lookup = (((255-pixelvalues))+1);
R2(Hh,Ww) = Remapping_schedule(row_lookup,9);

end

end

end

end
% -------------------------- Rebuild Images ---------------------------
Lnew = zeros(Image_Height, Image_Width, 3);
Rnew = zeros(Image_Height, Image_Width, 3);
for Hhh = 1:Image_Height;

for Www = 1:(Image_Width*3);

if Www <= Image_Width;

Lnew(Hhh,Www,1) = L2(Hhh,Www);
Rnew(Hhh,Www,1) = R2(Hhh,Www);

elseif Www > Image_Width & Www <= (Image_Width*2);

Lnew(Hhh,(Www-Image_Width),2) = L2(Hhh,Www);
Rnew(Hhh,(Www-Image_Width),2) = R2(Hhh,Www);

else

Lnew(Hhh,(Www-(Image_Width*2)),3) =
L2(Hhh,Www);
Rnew(Hhh,(Www-(Image_Width*2)),3) =
R2(Hhh,Www);

end

end

end
Lnew = uint8(Lnew);
Rnew = uint8(Rnew);
imwrite(Lnew, ‘zero_D_dimming_Image_L.bmp’, ‘BMP’);
imwrite(Rnew, ‘zero_D_dimming_Image_R.bmp’, ‘BMP’);
%% --------------------------------------------------------------------
% --------------------------- PCR -------------------------------------
original_left = imread(‘zero_D_dimming_Image_L.bmp’);
original_right = imread(‘zero_D_dimming_Image_R.bmp’);
% ------ Resize image to display width in pixels (if necessary) ------
x = size(original_left);
pic_height = x(:,1);
pic_width = x(:,2);
% --------------- Converting left and rights to double ----------------
intended_left = imresize(original_left, [480 800]);
intended_right = imresize(original_right, [480 800]);
intended_left = double(intended_left);
intended_right = double(intended_right);
% -------------------------- Simultaneous PCR -------------------------
% Must make sure that the crosstalk equation dimensions match image
% dimensions. That is if the displayed image is displaying pixels %
(1:480) the crosstalk equation j has to reference 1:480 (even if the %
actual image is centered on a black background.
Corrected_left(1:480,1:800,1:3) = zeros;
Corrected_right(1:480,1:800,1:3) = zeros;
crosstalk_percentage = load(‘WVGA02 Crosstalk Numbers
09_14_09.txt’);
% This is a file containing crosstalk data that specifies the amount of
% crosstalk by display location. Alternatively this could be done via %
a crosstalk equation.
for j = 1:800;

left_l = (crosstalk_percentage(j,1)/100);
right_k = (crosstalk_percentage(j,2)/100);
Weights = [(1-left_l),left_l;right_k,(1-right_k)];
for i = 1:480;

for k = 1:3;

PixelValues(1,1) = intended_left(i,j,k);
PixelValues(1,2) = intended_right(i,j,k);
PCRValues=[Weights\PixelValues‘]’;
Corrected_left(i,j,k) = PCRValues(1,1);
Corrected_right(i,j,k) = PCRValues(1,2);

end

end

end
background_left(1:480,1:800,1:3) = zeros;
background_left(1:480,1:800,1:3) = Corrected_left;
background_left = uint8(background_left);
background_right(1:480,1:800,1:3) = zeros;
background_right(1:480,1:800,1:3) = Corrected_right;
background_right = uint8(background_right);
% ---------- Write Corrected Left and Right Images to File ---------------
OUTPUT_IMAGE_NAME_L =
strcat(‘PCR_and_zero_D_dimmed_Image_L.bmp’);
OUTPUT_IMAGE_NAME_R =
strcat(‘PCR_and_zero_D_dimmed_Image_R.bmp’);
imwrite(background_left, OUTPUT_IMAGE_NAME_L, ‘BMP’);
imwrite(background_right, OUTPUT_IMAGE_NAME_R, ‘BMP’);

1. A method of performing zero-D dimming and reducing perceived image crosstalk in a multiview display comprising:
providing an image stream to a display, the display comprising a horizontal dimension that extends from a first side of the display to an opposing second side of the display, the image stream comprising a temporal sequence of images where at least a first image view and then a second image view is displayed on the display in a time sequential manner;
remapping pixel luminance values for the first image view and the second image view by applying a non-constant remapping function to original pixel luminance values of the first image view and the second image view in order to generate new pixel luminance values; and
conditioning the temporal sequence of images before the temporal sequence of images is displayed on the display to reduce perceived displayed image crosstalk between the at least first image view and the second image view, the conditioning comprising modifying a color intensity of, at least selected, pixels along the horizontal dimension based on a non-constant crosstalk correction function for the horizontal dimension.

2. The method of claim 1, wherein the image stream provides an autostereoscopic display and the first image view provides images primarily to a right eye of a viewer of the display and the second image view provides images primarily to a left eye of the view of the display, forming a perceived three dimensional display image.

3. The method of claim 1, wherein the image stream provides a dual view display and the first image view provides images primarily to a first viewer of the display and the second image view provides images primarily to a second viewer of the display.

4. The method of claim 1, wherein the non-constant crosstalk correction function is a non-linear function.

5. The method of claim 1, wherein the non-constant remapping function comprises a linear remapping.

6. The method of claim 1, wherein the non-constant remapping function comprises a curved remapping.

7. The method of claim 1, wherein the conditioning step further comprises adjusting the color intensity based upon user feedback concerning perceived crosstalk reduction of the first and second image views.

8. The method of claim 1, wherein remapping step comprises generating the new pixel luminance values within a sub-range of a full range of the pixel luminance values.

9. The method of claim 1, wherein the remapping step is performed before the conditioning step.

10. A method of performing zero-D dimming and reducing perceived image crosstalk in a multiview display comprising:
providing an image stream to a display, the display comprising a horizontal dimension that extends from a first side of the display to an opposing second side of the display, the image stream comprising a temporal sequence of images where at least a first image view and then a second image view is displayed on the display in a time sequential manner;
remapping pixel luminance values for the first image view and the second image view by applying a non-constant remapping function to original pixel luminance values of the first image view and the second image view in order to generate new pixel luminance values; and
conditioning the first image view and the second image view of the image stream before the image stream is displayed on the display to reduce perceived displayed image crosstalk between the first image view and second image view, the conditioning comprising modifying a color intensity of, at least selected, pixels along the horizontal dimension based on a non-constant crosstalk correction function for the horizontal dimension, and rescaling a color intensity range of the first image view and second image view so that the modified color intensity is within the color intensity range.

11. The method of claim 10, wherein color intensity of each color is rescaled so that the modified color intensity of each color is within the color intensity range for that color.

12. The method of claim 10, wherein the image stream provides an autostereoscopic display and the first image view provides images primarily to a right eye of a viewer of the display and the second image view provides images primarily to a left eye of the view of the display, forming a perceived three dimensional display image.

13. The method of claim 10, wherein the image stream provides a dual view display and the first image view provides images primarily to a first viewer of the display and the second image view provides images primarily to a second viewer of the display.

14. The method of claim 10, wherein the non-constant crosstalk correction function is a non-linear function.

15. The method of claim 10, wherein the non-constant remapping function comprises a linear remapping.

16. The method of claim 10, wherein the non-constant remapping function comprises a curved remapping.

17. The method of claim 10, wherein the conditioning step further comprises adjusting the color intensity based upon user feedback concerning perceived crosstalk reduction of the first and second image views.

18. The method of claim 10, wherein remapping step comprises generating the new pixel luminance values within a sub-range of a full range of the pixel luminance values.

19. A computer program product containing instructions in a computer-readable media for use in controlling the operation of a processor to perform the steps of:
providing an image stream to a display, the display comprising a horizontal dimension that extends from a first side of the display to an opposing second side of the display, the image stream comprising a temporal sequence of images where at least a first image view and then a second image view is displayed on the display in a time sequential manner;
remapping pixel luminance values for the first image view and the second image view by applying a non-constant remapping function to original pixel luminance values of the first image view and the second image view; and
conditioning the temporal sequence of images before the temporal sequence of images is displayed on the display to reduce perceived displayed image crosstalk between the at least first image view and the second image view, the conditioning comprising modifying a color intensity of, at least selected, pixels along the horizontal dimension based on a non-constant crosstalk correction function for the horizontal dimension.

20. A computer program product containing instructions in a computer-readable media for use in controlling the operation of a processor to perform the steps of:
providing an image stream to a display, the display comprising a horizontal dimension that extends from a first side of the display to an opposing second side of the display, the image stream comprising a temporal sequence of images where at least a first image view and then a second image view is displayed on the display in a time sequential manner;
remapping pixel luminance values for the first image view and the second image view by applying a non-constant remapping function to original pixel luminance values of the first image view and the second image view in order to generate new pixel luminance values; and
conditioning the first image view and the second image view of the image stream before the image stream is displayed on the display to reduce perceived displayed image crosstalk between the first image view and second image view, the conditioning comprising modifying a color intensity of, at least selected, pixels along the horizontal dimension based on a non-constant crosstalk correction function for the horizontal dimension, and rescaling a color intensity range of the first image view and second image view so that the modified color intensity is within the color intensity range.

21. A method of reducing perceived image crosstalk in a multiview display comprising:
providing an image stream to a display, the display comprising a horizontal dimension that extends from a first side of the display to an opposing second side of the display, the image stream comprising a temporal sequence of images where at least a first image view and then a second image view is displayed on the display in a time sequential manner; and
conditioning the temporal sequence of images before the temporal sequence of images is displayed on the display to reduce perceived displayed image crosstalk between the at least first image view and the second image view, the conditioning comprising modifying a color intensity of, at least selected, pixels along the horizontal dimension based on a non-constant crosstalk correction function for the horizontal dimension and based upon user feedback concerning perceived crosstalk reduction of the first and second image views.

22. The method of claim 21, further comprising displaying to the user a series of test image views with varying amounts of perceived crosstalk reduction.

23. A method of reducing perceived image crosstalk in a multiview display comprising:
providing an image stream to a display, the display comprising a horizontal dimension that extends from a first side of the display to an opposing second side of the display, the image stream comprising a temporal sequence of images where at least a first image view and then a second image view is displayed on the display in a time sequential manner; and
conditioning the temporal sequence of images before the temporal sequence of images is displayed on the display to reduce perceived displayed image crosstalk between the at least first image view and the second image view, the conditioning comprising modifying a color intensity of, at least selected, pixels along the horizontal dimension based upon user feedback concerning perceived crosstalk reduction of the first and second image views.

24. The method of claim 23, further comprising displaying to the user a series of test image views with varying amounts of perceived crosstalk reduction.
